(19) United States
(12) Patent Application Publication
(10) Pub. No.: US 2009/0180567 A1
(43) Pub. Date: Jul. 16, 2009

(54) TRANSMISSION DEVICE, MIMO COMMUNICATION SYSTEM, AND TRANSMISSION DIVERSITY METHOD

(76) Inventors: Xiaoming She, Beijing (CN); Jifeng Li, Kanagawa (JP)

Correspondence Address: Dickinson Wright PLLC;James E. Ledbetter, Esq., International Square, 1875 Eye Street, N.W., Suite 1200, Washington, DC, 20006, US

(21) Appl. No.: 12/092,895

(22) PCT Filed: Nov. 16, 2006
(86) PCT No.: PCT/JP2006/322874

§ 371 Date: May 7, 2008

(30) Foreign Application Priority Data
Nov. 16, 2005 (CN) 200510125388.9

(51) Int. Cl. H04B 7/02

(52) U.S. Cl. 375/267

(57) ABSTRACT

Provided are a transmission device and a transmission diversity method, which can suppress degradation of a transmission diversity performance even under the circumstances having a space correlation, in the case of performing a transmission diversity MIMO communication. The transmission device comprises an orthogonal conversion unit (201) for multiplexing an M-number of source symbols by an orthogonal conversion, to form an N-number of transmission symbols, and a beam forming unit (204) for changing the transmission symbols of the N-number one by one into beams by using the beam forming parameters of the N-number, thereby to transmit the transmission symbol beams timely sequentially one by one from a plurality of antennas. As a result, the beam forming unit (204) can form the transmission beam, from which the correlation between the individual transmission code channels is eliminated and from which the inter-code interference is eliminated, and the orthogonal conversion unit (201) can improve the diversity synthesis number of the source symbols.

### TECHNICAL FIELD

The present invention relates to a transmission diversity technique in a multiple-input multiple-output (MIMO) system. More specifically, the present invention relates to a transmitting apparatus, MIMO communication system and transmission diversity method that are able to effectively enhance transmission diversity performance in a spatial correlation MIMO communication system.

### BACKGROUND ART

One of main problems which future radio communication systems will face is that information transmission rate will increase more. A MIMO technique is one of indispensable techniques that should be adopted for future radio communications to realize this purpose with limited frequency spectral resources. In a MIMO communication system, the transmitting side transmits signals using a plurality of antennas and the receiving side receives spatial signals using a plurality of antennas. Studies have shown that the MIMO technique can substantially improve channel capacities compared to a conventional transmitting method using a single antenna and thereby also improve information transmission rates.

In terms of the transmission method, the MIMO system can be divided roughly into two types. These are a MIMO transmission system based on spatial multiplexing and a MIMO transmission system based on spatial diversity (e.g., see Patent Document 1 and Non-Patent Document 1). The basic concept of the spatial multiplexing MIMO transmission system is that transmission signals from respective transmitting antennas are independent of each other to obtain optimum transmission rates. Typical examples of spatial multiplexing MIMO transmission system include a V-BLAST system announced by Bell Telephone Laboratories.

Unlike the spatial multiplexing MIMO transmission system, the spatial diversity MIMO transmission system normally requires signal pre-processing before transmission to improve transmission diversity capability in exchange for certain loss of a transmission rate and thereby obtain higher MIMO reception performance. There are many types of pre-processing methods used in the spatial diversity MIMO transmission system and the most basic one is a space-time coding method.

FIG. 1 shows the configuration of a MIMO communication system carrying out conventional spatial diversity.

In this configuration, the transmitting side and the receiving side transmit and receive signals using n_{T} and n_{R} antennas, respectively. On the transmitting side, coding and modulating section 101 encodes and modulates a bit stream to be transmitted and thereby forms transmission symbols. Next, serial-to-parallel converting section (S/P section) 102 divides the serial code stream into M parallel code streams. Space-time coding section 103 is provided after serial-to-parallel converting section 102 and this space-time coding section 103 applies space-time coding processing to transmission symbols.

More specifically, each time space-time coding section 103 reads M parallel symbols inputted from serial-to-parallel converting section 102, space-time coding section 103 carries out space-time coding of this M×1 code vector according to a predetermined space-time coding rule and generates n_{T}×N code matrix X. This n_{T}×N code matrix X is transmitted through n_{T} transmitting antennas 104 within N consecutive transmission time intervals. In this case, one column of code matrix X is transmitted on a per transmission time interval basis. Here, both M and N are natural numbers and M/N is defined as coding efficiency of space-time coding. Space-time coding itself is also divided into many types such as space-time block code and space-time trellis code, depending on differences in space-time coding rules adopted.

On the receiving side, n_{R} receiving antennas 111 receive all signals in space. Next, channel estimation section 115 carries out a channel estimation based on pilot signals in the received signal or other methods and thereby estimates channel characteristic matrix H at the present time (in a MIMO system, the channel characteristic can be described as one n_{R}×n_{T} matrix). Space-time decoding section 112 performs space-time decoding on the received signal using channel characteristic matrix H. The space-time decoding can be regarded as a reverse operation of space-time coding on the transmitting side. Outputs of space-time decoding are sequentially inputted to parallel-to-serial converting section 113 and demodulating and decoding section 114, and received data is outputted from demodulating and decoding section 114.

Although a transmission diversity MIMO communication system is inferior in transmission rates to a spatial multiplexing MIMO communication system (the space-time coding efficiency of the latter can be regarded as n_{T}), the diversity performance of a transmission signal can be enhanced by a pre-processing technique realized on the transmitting side and therefore higher MIMO reception performance can be achieved. In recent years, many professionals and scholars are conducting research in transmission diversity techniques in MIMO and releasing many effective space-time coding design methods.

### Patent Document 1: US20050047517A1

Non-Patent Document 1: “Some Results and Insights on the Performance Gains of MIMO Systems,” “IEEE JOURNAL ON SELECTED AREAS IN COMMUNICATIONS, VOL. 21, NO. 5” , “June 2003,” “written by Severine Catreux, Larry J. Greenstein, Vinko Erceg,” “published by IEEE,” “p. 840, Table I: SUMMARY OF ALL SYSTEMS STUDIED (P=TOTAL TRANSMIT POWER, h=INSTANTANEOUS PATH GAIN FROM TRANSMIT ANTENNA j TO RECEIVE ANTENNA i)” (© 2005 IEEE).

### DISCLOSURE OF INVENTION

### Problems to be Solved by the Invention

By the way, most of the studies on transmission diversity methods in the current MIMO system assumes that channels of the MIMO system are independent of each other. However, in an actual MIMO system, channels of the MIMO system are often correlated with each other. There are many factors that, for example, the distance of arrangement intervals between antennas is insufficient, there are not much scatterings around the antennas or there is a direct wave (LOS) between transmitting and receiving sides, which causes correlation between channels of the MIMO system. When there is a correlation between channels in the MIMO system, channel characteristic matrix H can be represented by the following equation.

### (Equation 1)

H=Rᵣ^{1/2}H_{w}Rₜ^{1/2} [1]

In equation 1, H_{w} represents independent n_{R}n_{T} MIMO channel characteristic matrix, and Rᵣ and Rₜ represent n_{R}×n_{R} and n_{T}×n_{T} reception and transmission correlation matrices, respectively.

According to conventional studies, correlation between antennas in a MIMO system in an actual environment lowers the rank of MIMO channels, thereby lowering the effective number of transmission diversity combination and causing deterioration of transmission diversity performance. For this reason, a new transmission diversity technique needs to be considered for a spatial correlation MIMO system.

It is therefore an object of the present invention to, when transmission diversity MIMO communication is carried out, provide a transmitting apparatus, MIMO communication system and transmission diversity method that are able to reduce deterioration of transmission diversity performance even in a condition where there is spatial correlation.

### Means for Solving the Problem

An aspect of the transmitting apparatus according to the present invention that is used in a multiple-input multiple-output communication system includes: an orthogonal transforming section that forms N transmission symbols by multiplexing M original-symbols through orthogonal transformation, M and N being natural numbers; and a beam forming section that changes the N transmission symbols into beams one symbol by one symbol using N beam forming parameters and transmit the transmission symbols changed into the beams in a time sequence one symbol by one symbol from a plurality of antennas.

According to this configuration, transmission symbols are transmitted in beam, so that it is possible to remove correlation between transmission code channels, transmit only one symbol at each timing and, consequently, cancel inter-code interference. In addition, original-symbols are orthogonally transformed to obtain transmission symbols, so that a plurality of original-symbols are multiplexed over each transmission symbol and the number of original-symbols subjected to diversity combination can be increased.

Furthermore, an aspect of the communication system according to the present invention has a transmitting apparatus and a receiving apparatus for carrying out multiple-input multiple-output communication between the transmitting apparatus and the receiving apparatus, in which: the transmitting apparatus comprises: an orthogonal transforming section that multiplexes M original-symbols through orthogonal transformation and forms N transmission symbols, M and N being natural numbers; and a beam forming section that changes the N transmission symbols into beams one symbol by one symbol using N beam forming parameters and transmits the transmission symbols changed into the beams in a time sequence one symbol by one symbol from a plurality of antennas; and the receiving apparatus comprises a parameter determining section that determines the N beam forming parameters based on secondary statistic characteristics of a channel and feeds back the determined N beam forming parameters to the transmitting apparatus through a feedback channel.

According to this configuration, the transmitting apparatus is able to change transmission symbols into beams using appropriate beam forming parameters taking into consideration the received condition at the receiving apparatus and thereby further improve the error rate characteristic at the receiving apparatus.

### Advantageous Effect of the Invention

When transmission diversity MIMO communication is carried out, the present invention is able to realize a transmitting apparatus, MIMO communication system and transmission diversity method that are able to reduce deterioration of transmission diversity performance even in a condition where there is spatial correlation.

### BRIEF DESCRIPTION OF DRAWINGS

FIG. 1 shows the configuration of a MIMO communication system using conventional spatial diversity;

FIG. 2 shows the configuration of a MIMO communication system according to an embodiment of the present invention;

FIG. 3 is a flowchart illustrating processing executed on the transmitting side and the receiving side;

FIG. 4 is a flowchart illustrating processing of determining transmission parameters executed on the receiving side; and

FIG. 5 is a characteristic diagram showing a comparison of performance between the method of the present invention and a conventional method.

### BEST MODE FOR CARRYING OUT THE INVENTION

Hereinafter, an embodiment of the present invention will be explained in detail with reference to the accompanying drawings.

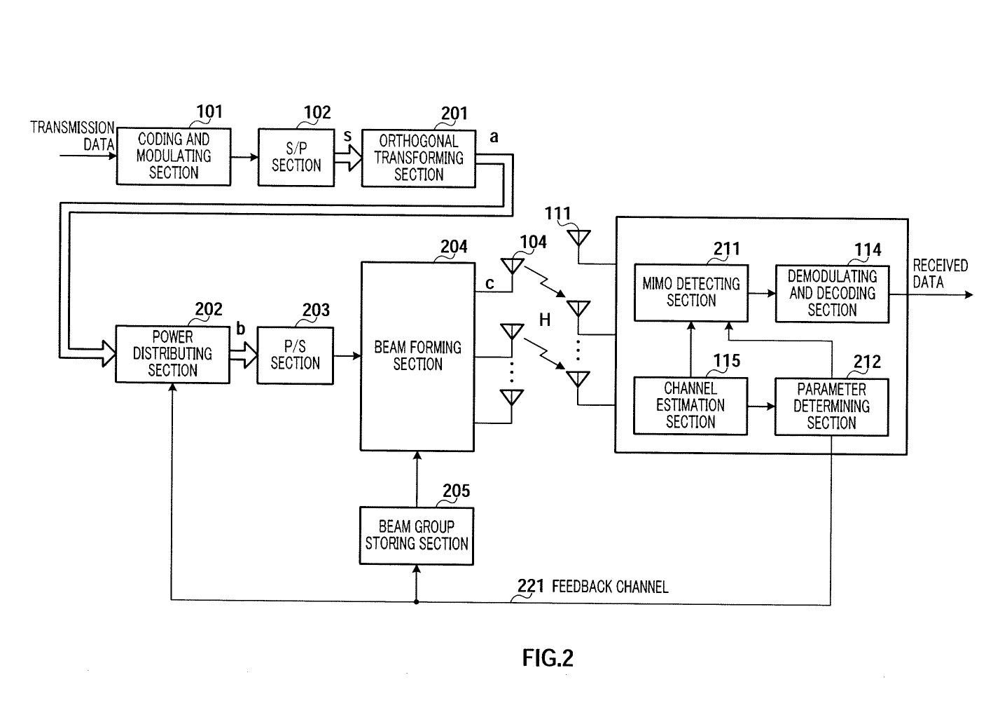

FIG. 2 shows the configuration of a MIMO communication system according to an embodiment of the present invention.

As shown in FIG. 2, the transmitting side (transmitting apparatus) and the receiving side (receiving apparatus) transmit and receive signals using n_{T} and n_{R} antennas, respectively. The transmitting apparatus encodes and modulates a bit stream to be transmitted through coding and modulating section 101 and thereby forms a code stream. Next, serial-to-parallel converting section (S/P section) 102 carries out serial-to-parallel conversion of the serial code stream and divides the code stream into M parallel code streams. That is, the output of serial-to-parallel converting section 102 is an M×1 vector and is expressed by “s” in FIG. 2. Here, s=[S₁, s₂, . . . , s_{M}]^{T}.

Orthogonal transforming section 201 is provided after serial-to-parallel converting section 102. Orthogonal transforming section 201 carries out orthogonal transformation of the parallel code streams and then outputs an N×1 vector a=Us=[a₁, a₂, . . . , a_{N}]^{T}. Here, U is an (N×M) orthogonal matrix and satisfies U^{H}U=I (unit matrix).

After orthogonal transformation, power distributing section 202 distributes power to the code streams and outputs vector b=Pa=[b₁, b₂, . . . , b_{N}]^{T} expressed by N×1. P represents a power distribution matrix, P=diag{√P₁, √P₂, . . . , √P_{N}} and satisfies the following equation. That is, total power becomes constant at Pₜₒₜₐₗ.

$$\begin{matrix}( Equation 2 ) & \\ {\sum }_{i} {P}_{i} = {P}_{total} & [ 2 ]\end{matrix}$$

Next, parallel-to-serial converting section 203 converts the parallel code streams to a serial code stream and beam forming section 204 transmits the serial code stream using an applicable beam through transmitting antenna 104.

Beam group W={w₁, w₂, . . . , w_{N}} to be used for transmission is stored in beam group storing section 205 before transmission of data symbols. Each transmission beam wᵢ is a (n_{T}×1) vector.

The transmitting apparatus transmits data symbols as follows. That is, the transmitting apparatus transmits b₁w₁ using n_{T} transmitting antennas 104 at transmission timing 1, and transmits b₂w₂ using n_{T} transmitting antennas 104 at transmission timing 2. Hereinafter, in the same way, subsequent N transmission symbols are transmitted in a time sequence using beams w₁, w₂, . . . , w_{N} in beam group W. That is, one symbol is transmitted with one beam at each transmission timing.

The parameters which the transmitting apparatus needs to carry out power distribution and beam formation, that is, both power distribution matrix P and transmission beam group W, are determined by the receiving apparatus and are fed back to the transmitting apparatus through the feedback channel. Power distribution matrix P and transmission beam group W are determined by the receiving apparatus based on the secondary statistic characteristic of the MIMO channel. Therefore, the parameter determining operation and parameter feedback operation processes are long-term processes and the time interval between two consecutive determining operations and two consecutive parameter feedback operations is long. The more specific processes of determining parameters P and W by the receiving apparatus will be described later.

The receiving apparatus first receives spatial signals through n_{R} receiving antennas 111 and then carries out the following three operations.

(1) Channel estimation section 115 carries out channel estimation based on the received signal and estimates channel characteristic matrix H at the present time. For example, channel estimation section 115 estimates channel characteristic matrix H at the present time based on a pilot of the received signal.

(2) It is decided whether or not the parameters which the transmitting apparatus needs to carry out power distribution and beam formation, that is, power distribution matrix P and transmission beam group W, need to be recalculated, and, if the transmitting apparatus needs to recalculate the parameters, parameter determining section 212 calculates the parameters and feeds back the result to the transmitting apparatus. As described above, the process of determining power distribution matrix P and transmission beam group W by the receiving apparatus is a long-term process, P and W need not be calculated at all timings. The actual system may set a timer and determine parameters P and W and carry out feedback operation at time interval T.

(3) MIMO detecting section 211 detects a signal received at the present time. The more specific operation will be described in detail later.

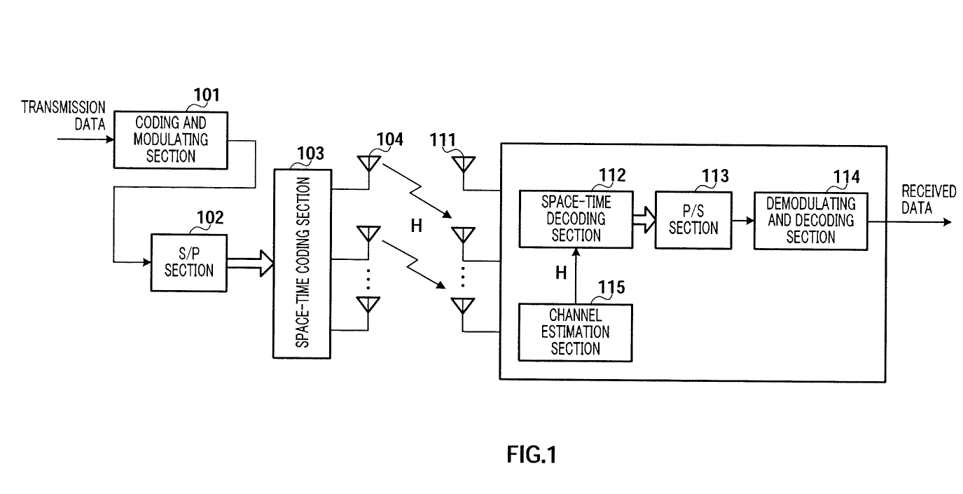

The transmission diversity method of the MIMO communication system of this embodiment mainly has the following difference from the transmission diversity method of the conventional MIMO system shown in FIG. 1.

Transmission symbols are transmitted in beam, and only one symbol is transmitted at each timing. That is, transmission symbols are orthogonal to each other in the time domain. The former provides an advantage of enabling removal of correlation between transmission code channels and the latter provides an advantage of enabling cancellation of inter-code interference which occurs when a plurality of symbols are transmitted at the same timing according to the conventional method.

Transmission symbols are obtained by orthogonally transforming original-symbols. An advantage of this is to multiplex a plurality of original-symbols over each transmission symbol and increase the number of original-symbols subjected to diversity combination.

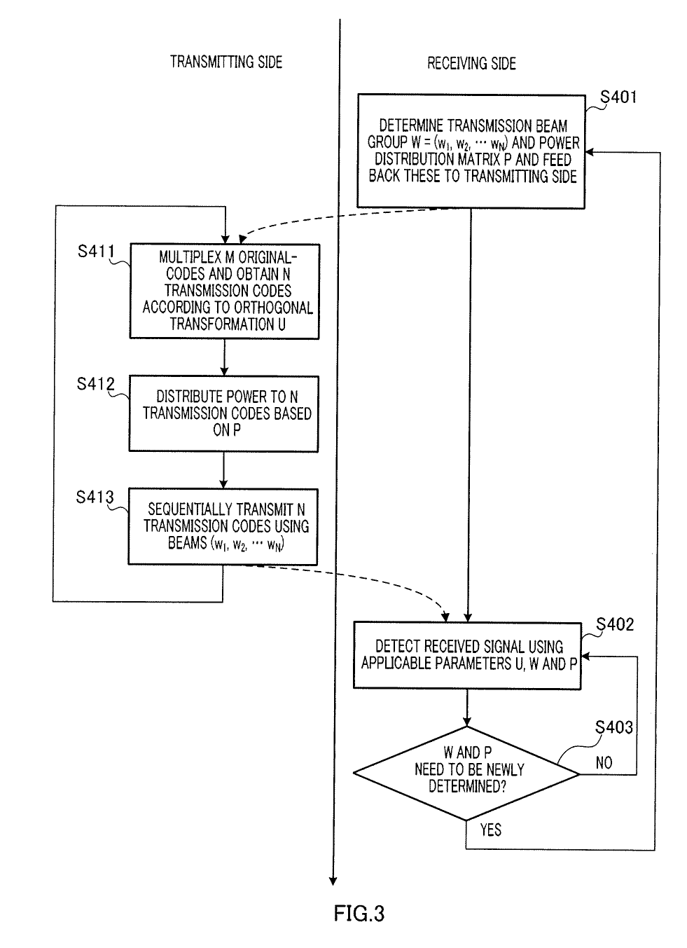

More specifically, the transmission diversity method of this embodiment can be expressed as shown in FIG. 3. FIG. 3 is a flowchart of the operation executed by the transmitting side and the receiving side of this embodiment.

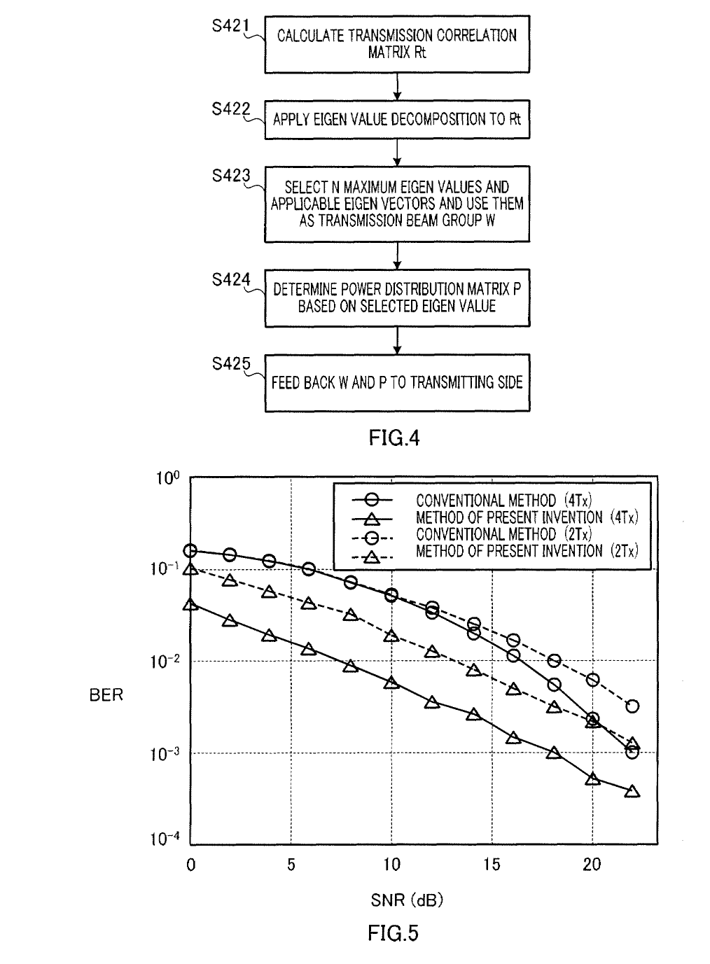

As shown in FIG. 3, in step S401, the receiving apparatus determines transmission beam group W={w₁, w₂, . . . , w_{N}} and power distribution matrix P=diag{√P₁, √P₂, . . . , √P_{N}} and feeds back the determination result to the transmitting apparatus through feedback channel 221. The power distribution matrix is handed over to power distributing section 202 and the beam group is stored in beam group storing section 205 of the transmitting apparatus. Next, the detailed processing of step S401 will be described later using FIG. 4.

In step S411, orthogonal transforming section 201 orthogonally transforms original transmission symbols. The original transmission symbols are, for example, a M×1 vector as s=[s₁, s₂, . . . , s_{M}]^{T} in FIG. 2. The orthogonal transformation operation is carried out by the left product, (N×M) orthogonal matrix U, and the output after orthogonal transformation becomes N×1 vector a=Us=[a₁, a₂, . . . , a_{N}]^{T}. Here, there is no special requirement for orthogonal transformation matrix U and it is only required to satisfy orthogonality. That is, only U^{H}U=I (unit matrix) is required. When, for example, M=N=2, M=N=3 or M=N=4, an orthogonal transformation matrix can be obtained using a matrix as shown in the following equation.

$$\begin{matrix}( Equation 3 ) & \\ {U}_{2} = \frac{\sqrt{2}}{2} [ \begin{matrix}1 & 1 \\ 1 & - 1\end{matrix} ] \\ {U}_{3} = \frac{1}{2} [ \begin{matrix}1 & \sqrt{2} & 1 \\ 1 & - \sqrt{2} & 1 \\ \sqrt{2} & 0 & - \sqrt{2}\end{matrix} ] \\ {U}_{4} = \frac{1}{2} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ] & [ 3 ]\end{matrix}$$

In step S412, power distributing section 202 carries out power distribution of output a=Us=[a₁, a₂, . . . , a_{N}]^{T} after orthogonal transformation, based on power distribution matrix P=diag{√P₁, √P₂, . . . , √P_{N}} fed back from the receiving side. Output b after power distribution is expressed by the following equation.

### (Equation 4)

b=Pa=[b₁,b₂, . . . ,b_{N}]^{T}=[\sqrt{P₁}a₁, \sqrt{P₂}a₂, . . . , \sqrt{P_{N}}a_{N}]^{T} [4]

In step S413, beam forming section 204 transmits N transmission symbols b=[b₁, b₂, . . . , b_{N}]^{T} after power distribution through antennas 104 using transmission beam group W={w₁, w₂, . . . , w_{N}}. More specifically, beam forming section 204 transmits symbol b₁ at transmission timing 1 using transmission beam w₁. That is, signal b₁w₁ is transmitted through n_{T} transmitting antennas at this time. Furthermore, beam forming section 204 transmits symbol b₂ at transmission timing 2 using transmission beam w₂. That is, signal b₂w₂ is transmitted through n_{T} transmitting antennas at this time. The same applies below. That is, with this embodiment, N transmission symbols are transmitted in a time sequence using beams in beam group W such that one symbol is transmitted with one beam at each transmission timing. In this way, the signal transmitted from transmitting antennas 104 in FIG. 2 is expressed as C=W·diag{b₁, b₂, . . . , b_{N}}. Here, C=[c₁, c₂, . . . c_{N}], cᵢ is an (n_{T}×1) vector, represents a transmission signal on an antenna at timing i, W=[w₁, W₂, . . . , w_{N}] and wᵢ is also an (n_{T}×1) vector.

The data transmission process from step S411 to step S413 is a repetition process and is executed each time a original code vector is transmitted.

When the transmitting apparatus transmits symbols as described above, the receiving apparatus receives signals transmitted in a time sequence by the transmitting apparatus with N beams through receiving antennas 111 in step S402, and then detects signals based on applicable parameters, that is, based on orthogonal matrix U, transmission beam group W, power distribution matrix P=diag{√P₁, √P₂, . . . , √P_{N}} and channel characteristic matrix H at the present time.

More specifically, MIMO detecting section 211 first combines the signals received through the n_{R} receiving antennas as follows.

When signals received in consecutive N time intervals are defined as X based on the above described definition, received signals X are expressed by the following equation.

### (Equation 5)

X=HC+[n₁ n₂ . . . n_{N}] [5]

Here, X=[x₁, x₂, . . . , x_{N}] in equation 5, and xᵢ represents a (n_{R}×1) vector and represents the signal received through the antennas at timing i. nᵢ is a noise vector.

When xᵢ is subjected to maximum ratio combination, y=[y₁, y₂, . . . , y_{N}] is obtained. Here, yᵢ is expressed by the following equation.

### (Equation 6)

yᵢ=(Hwᵢ)xᵢ [6]

Therefore, through combination, MIMO detecting section 211 obtains received signals y expressed by the following equation.

### (Equation 7)

y=H₀s+a [7]

Equivalent channel H₀ in equation 7 is expressed by the following equation, α=[α₁, α₂, . . . , α_{N}] and αᵢ represents white Gaussian noise having a variance of (Hwᵢ)^{H}Hwᵢσ².

$$\begin{matrix}( Equation 8 ) & \\ {H}_{0} = [ \begin{matrix}{( {Hw}_{1} )}^{H} {Hw}_{1} & & & \\ & {( {Hw}_{2} )}^{H} {Hw}_{2} & & \\ & & ⋱ & \\ & & & {( {Hw}_{1} )}^{H} {Hw}_{1}\end{matrix} ] [ \begin{matrix}\sqrt{{P}_{1}} & & & \\ & \sqrt{{P}_{2}} & & \\ & & ⋱ & \\ & & & \sqrt{{P}_{N}}\end{matrix} ] U & [ 8 ]\end{matrix}$$

Next, MIMO detecting section 211 detects a combined signal using a conventional MIMO detection method. As is apparent from equation 7, the format of the combined signal is completely the same as the format of the signal transmitted in MIMO. Therefore, the transmission signal can be detected using any conventional MIMO detection methods such as linear detection, interference cancellation detection or maximum likelihood detection here. The only difference is that the channel characteristic matrix used in conventional MIMO detection is replaced by equivalent channel characteristic matrix H₀ here.

Next, in step S403, the receiving apparatus decides whether or not the transmission beam group W={w₁, w₂, . . . , w_{N}} and power distribution matrix P=diag{√P₁, √P₂, . . . , √P_{N}} need to be redetermined for the transmitting apparatus. If they need to be redetermined, the process moves to step S401.

As described above, the channel statistic characteristic does not change for a long time, and so the estimation of the channel secondary statistic characteristic, determination of transmission beam group W and power distribution matrix P and feedback operation become a long-term process. That is, these processes are carried out once at a long time interval. The more specific time length is as the above described time T. Here, the time is measured, and, when the time interval from the timing when the previous transmission beam group is determined becomes T, the flow proceeds to step S401 and transmission beam group W and power distribution matrix P are newly determined.

Next, the operation of the receiving apparatus for determining the parameters P and W will be explained using FIG. 4.

In step S421, the receiving apparatus calculates transmission correlation matrix Rₜ. More specifically, the following two methods are available.

(1) Rₜ is calculated from Rₜ(i*T)=E{H^{H}H}. Here, Rₜ(i*T) represents the transmission correlation matrix calculated at timing i*T, T represents the time interval for calculating the correlation matrix and E{} represents that an average is calculated in time interval [(i−1)*T, i*T]. Generally, the T value is large, and so this step becomes a long-term process.

Furthermore, there are two methods of determining the T value in the actual system. The first one is a method of using an eigen value and determining the T value when the system is initialized. The second one is a method of using a variable T value. That is, this is the method of changing the T value according to changes in the condition of time variation of a channel (e.g., change in car speed). For example, it is preferable to reduce the T value when the channel variation over time becomes faster and increase the T value when the channel variation over time becomes slower.

(2) Rₜ(i*T) is calculated from Rₜ(i*T)=ρRₜ((i−1)*T)+(1−ρ)E{H^{H}H}. That is, the channel correlation value Rₜ(i*T) at timing i*T is determined by carrying out weighting based on channel correlation value Rt((i−1)*T) at timing (i−1) T and average value E{H^{H}H} within time interval [(i−1)*T, i*T]. ρ is a forgetting factor and the numerical value of ρ is selected when the system is initialized.

In step S422, the receiving apparatus carries out eigen value decomposition (EVD) of transmission correlation matrix Rₜ calculated in step S421 and obtains n_{T} eigen vectors and n_{T} eigen values. These n_{T} eigen vectors have a one-to-one correspondence with n_{T} eigen values.

In step S423, the receiving apparatus selects maximum N eigen values λᵢ from among the n_{T} eigen values. Here, λᵢ satisfies i=1, 2, . . . , N and λ₁≧λ₂≧ . . . ≧λ_{N}. The receiving apparatus then obtains transmission beam group W={w₁, w₂, . . . , w_{N}} including N beams. Here, wᵢ is an eigen vector matching with the eigen value λᵢ.

In step S424, the receiving apparatus determines power distribution matrix P=diag{√P₁, √P₂, . . . , √P_{N}} . Here, there are three power distribution methods.

(1) Equal power distribution method. That is, this method determines power distribution based on Pᵢ=Pₜₒₜₐₗ/N, where i=1, 2, . . . , N. Here, Pₜₒₜₐₗ represents a total transmission power limit.

(2) Power distribution method based on the water-pouring theory. This method uses the N eigen values calculated in step S423 and obtains power distribution value Pᵢ=(μ−Nσₙ²/Pₜₒₜₐₗλᵢ)₊ according to the water-pouring theory. Here, suppose μ represents constant w (the μ value is selected, and so total transmission power restriction Pₜₒₜₐₗ is satisfied), σₙ² represents a noise variance and the function (x)₊ is expressed by the following equation.

$$\begin{matrix}( Equation 9 ) & \\ {( x )}_{+} = \{ \begin{matrix}x & x \geq 0 \\ 0 & x < 0\end{matrix} & [ 9 ]\end{matrix}$$

(3) Power distribution method based on eigen values. A power distribution result obtained using this method is as shown in the following equation.

$$\begin{matrix}( Equation 10 ) & \\ {P}_{i} = \frac{{λ}_{i} {P}_{total}}{{\sum }_{i = 1}^{N} {λ}_{i}} & [ 10 ]\end{matrix}$$

According to this method, the power distribution on each beam is proportional to the magnitude of the applicable eigen value. This method has a similar concept to the above described power distribution according to the water-pouring theory. That is, this method distributes greater transmission power to beams with greater eigen values. However, power distribution according to this method is less complicated.

In step S425, the receiving apparatus feeds back calculated transmission beam group W={w₁, w₂, . . . , w_{N}} and power distribution matrix P=diag{√P₁, √P₂, . . . , √P_{N}} to the transmitting apparatus through feedback channel 221. Suppose both the time interval for feedback and the time interval for determining a correlation matrix are T. In this way, the parameter determining operation of the receiving apparatus is completed.

In this way, when the receiving apparatus feeds back the determined parameters to the transmitting apparatus, the transmitting apparatus carries out pre-processing of the transmission signal at each transmission timing based on transmission beam group W={w₁, w₂, . . . , w_{N}} and power distribution matrix P=diag{√P₁, √P₂, . . . , √P_{N}} fed back from the receiving apparatus, and transmits the signal after processing.

FIG. 5 shows a comparison of performance between the transmission diversity method of this embodiment and the conventional transmission diversity method. FIG. 5 shows a comparison of system BER (bit error rate) performance between the transmission diversity method of this embodiment and the conventional transmission diversity method. FIG. 5 shows a comparison of performance in two conditions where the number of transmitting antennas n_{T} are two and four. The applicable transmission rates in these two environments are one and one-half, respectively. The number of receiving antennas n_{R} is one in both cases, and the receiving side adopts ZF (Zero Forcing) detection and the modulation scheme is QPSK. Furthermore, the transmission correlation matrices for two transmitting antennas and four transmitting antennas are expressed by the following equations, respectively, and suppose, in a condition where the antenna interval according to the ITU (International Telecommunication Union) is λ/2, transmission direction is 20° and angle range is 5°, reception for both the transmission correlation matrices are uncorrelated.

$$\begin{matrix}( Equation 11 ) & \\ {R}_{2} = [ \begin{matrix}1 & 0.97 {e}^{0.34 π j} \\ 0.97 {e}^{- 0.34 π j} & 1\end{matrix} ] & [ 11 ] \\ ( Equation 12 ) & \\ {R}_{4} = [ \begin{matrix}1 & 0.97 {e}^{034 π j} & 0.89 {e}^{0.68 πj} & 0.77 {e}^{0.99 πj} \\ 0.97 {e}^{- 0.34 πj} & 1 & 0.97 {e}^{0.34 πj} & 0.89 {e}^{0.68 πj} \\ 0.89 {e}^{- 0.68 πj} & 0.97 {e}^{- 0.34 πj} & 1 & 0.97 {e}^{0.34 πj} \\ 0.77 {e}^{- 0.99 πj} & 0.89 {e}^{- 0.68 πj} & 0.97 {e}^{- 0.34 πj} & 1\end{matrix} ] & [ 12 ]\end{matrix}$$

As is apparent from the result in FIG. 5, the method of this embodiment is able to obtain better BER performance compared to the conventional method.

As explained above, this embodiment provides orthogonal transforming section 201 that multiplexes M original-symbols through orthogonal transformation and forms N transmission symbols and beam forming section 204 that changes N transmission symbols into beams one symbol by one symbol using N beam forming parameters and transmits the transmission symbols changed into beams in a time sequence one symbol by one symbol from a plurality of antennas. By this means, beam forming section 204 is able to remove correlation between transmission code channels and form transmission beams which cancel inter-code interference and orthogonal transforming section 201 is able to increase the number of original-symbols subjected to diversity combination. As a result, when transmission diversity MIMO communication is carried out, it is possible to realize a transmitting apparatus and transmission diversity method that are able to reduce deterioration of transmission diversity performance even in a condition where there is spatial correlation.

Further, a case has been described with the above described embodiment where the receiving side must determine power distribution matrix P and beam formation group W and the transmitting side carries out the applicable power distribution operation before symbol transmission. However, the present invention is not limited to this, and, as understood by those skilled in the art, the power distribution matrix and power distribution operation only optimize power of each symbol to be transmitted and do not remove correlation between channels, and are therefore not indispensable.

Furthermore, the present invention is not limited to the above described embodiment and can be implemented modified in various ways.

The present application is based on Chinese Patent Application No.200510125388.9, filed on Nov. 16, 2005, the entire content of which is expressly incorporated by reference herein.

### INDUSTRIAL APPLICABILITY

When transmission diversity MIMO communication is carried out, the present invention has the effect to enable reducing deterioration of transmission diversity performance even in an environment where there is spatial correlation, and is widely applicable to wireless equipment for carrying out transmission diversity MIMO communication.

1. A transmitting apparatus used in a multiple-input multiple-output communication system, the apparatus comprising:
an orthogonal transforming section that forms N transmission symbols by multiplexing M original-symbols through orthogonal transformation, M and N being natural numbers; and
a beam forming section that changes the N transmission symbols into beams one symbol by one symbol using N beam forming parameters and transmit the transmission symbols changed into the beams in a time sequence one symbol by one symbol from a plurality of antennas.

2. The transmitting apparatus according to claim 1, further comprising a power distributing section that distributes power to the N transmission symbols using N power distribution coefficients matching with the N beam forming parameters.

3. A multiple-input multiple-output communication system comprising a transmitting apparatus and a receiving apparatus for carrying out multiple-input multiple-output communication between the transmitting apparatus and the receiving apparatus, wherein:
the transmitting apparatus comprises:
an orthogonal transforming section that multiplexes M original-symbols through orthogonal transformation and forms N transmission symbols, M and N being natural numbers; and
a beam forming section that changes the N transmission symbols into beams one symbol by one symbol using N beam forming parameters and transmits the transmission symbols changed into the beams in a time sequence one symbol by one symbol from a plurality of antennas; and
the receiving apparatus comprises a parameter determining section that determines the N beam forming parameters based on secondary statistic characteristics of a channel and feeds back the determined N beam forming parameters to the transmitting apparatus through a feedback channel.

4. The multiple-input multiple-output communication system according to claim 3, wherein:
the transmitting apparatus further comprises a power distributing section that distributes power to the N transmission symbols using N power distribution coefficients matching with the N beam forming parameters; and
the receiving apparatus further determines the N power distribution coefficients at the parameter determining section and feeds back the determined N power distribution coefficients to the transmitting apparatus through a feedback channel.

5. The multiple-input multiple-output communication system according to claim 3, wherein:
the receiving apparatus further comprises a channel estimation section that estimates a channel characteristic matrix; and
the parameter determining section finds a transmission correlation matrix based on the channel characteristic matrix, obtains a plurality of eigen vectors and a plurality of eigen values matching with the plurality of eigen vectors by carrying out eigen value decomposition of the transmission correlation matrix, selects N eigen vectors matching with maximum N eigen values of the plurality of eigen values from among the plurality of eigen vectors and determines the N eigen vectors as the N beam forming parameters.

6. The multiple-input multiple-output communication system according to claim 4, wherein the parameter determining section determines coefficients having the same value as the N power distribution coefficients.

7. The multiple-input multiple-output communication system according to claim 4, wherein the parameter determining section determines the N power distribution coefficients Pᵢ(i=1 to N) as Pᵢ=(μ−Nσₙ²/Pₜₒₜₐₗλᵢ)₊ using the N eigen values {λ₁, λ₂, . . . , λ₃} according to a water pouring method, where Pₜₒₜₐₗ is a total transmission power limit value, μ is such a constant that the total transmission power limit value Pₜₒₜₐₗ is set to a predetermined value, σₙ² is a noise variance and the function (x)₊ is a function that takes x when x is zero or greater and that takes zero when x is less than zero.

8. The multiple-input multiple-output communication system according to claim 5, wherein the parameter determining section determines the N power distribution coefficients such that the magnitude of the N power distribution coefficients are proportional to the eigen values.

9. The multiple-input multiple-output communication system according to claim 3, wherein the parameter determining section determines the N beam forming parameters at predetermined time intervals.

10. The multiple-input multiple-output communication system according to claim 9, wherein the parameter determining section makes shorter a time interval for determining the N beam forming parameters when a time variation of a channel is fast compared to when the time variation of the channel is slow.

11. A transmission diversity method in a multiple-input multiple-output communication system comprising:
forming N transmission symbols by multiplexing M original-symbols through orthogonal transformation, M and N being natural numbers; and
changing the N transmission symbols into beams one symbol by one symbol using N beam forming parameters and transmitting the transmission symbols changed into the beams in a time sequence one symbol by one symbol from a plurality of antennas.

12. The transmission diversity method according to claim 11, further comprising:
at the receiving apparatus that receives the transmission symbols, determining the N beam forming parameters based on a secondary statistic characteristic of a channel; and
at the receiving apparatus, feeding back the determined N beam forming parameters to the transmitting side through a feedback channel.
